(19) United States
(12) Patent Application Publication
(10) Pub. No.: US 2013/0258187 A1
(43) Pub. Date: Oct. 3, 2013

(54) CAMERA MODULE

(71) Applicants: Chuel-Jin PARK, Suwon-si (KR); Ick-Chan SHIM, Suwon-si (KR); Dong-Kyun LEE, Suwon-si (KR)

(72) Inventors: Chuel-Jin PARK, Suwon-si (KR); Ick-Chan SHIM, Suwon-si (KR); Dong-Kyun LEE, Suwon-si (KR)

(73) Assignee: SAMSUNG ELECTRO-MECHANICS CO., LTD., Suwon-si (KR)

(21) Appl. No.: 13/828,088

(22) Filed: Mar. 14, 2013

(30) Foreign Application Priority Data
Mar. 30, 2012 (KR) 10-2012-0033453

(51) Int. Cl. H04N 5/225

(52) U.S. Cl. CPC H04N 5/2254
USPC 348/374

(57) ABSTRACT

A camera module is disclosed. A camera module in accordance with an embodiment of the present invention includes: a housing; a lens barrel arranged inside the housing; an infrared filter fixed to one side of the lens barrel and having a window layer coated thereon so as to form a window area; an image sensor arranged beneath the infrared filter so as to correspond to the window area; and a printed circuit board having the image sensor mounted thereon.

### CROSS-REFERENCE TO RELATED APPLICATIONS

This application claims the benefit of Korean Patent Application No. 10-2012-0033453, filed with the Korean Intellectual Property Office on Mar. 30, 2012, the disclosure of which is incorporated herein by reference in its entirety.

### BACKGROUND

1. Technical Field

The present invention relates to a camera module that can reduce a height.

2 Background Art

Generally, camera modules can be applied to portable electronic devices, such as mobile phones, digital cameras, camcorders, portable multimedia players, etc. Owing to the advancement of digital camera technologies and data storage capacities, an increasing number of camera modules having greater specifications are increasingly installed.

It is preferable that the spill light or infrared ray around the camera module is blocked in order to improve the image quality of the camera module. Accordingly, a window area can be opened between a lens barrel and an image sensor in order to block the spill light or infrared ray. Here, window ribs can be formed to be protruded from the inside face toward the center of the housing, and the center of the window ribs is opened to form the window area. An infrared filter can be attached to the bottom face of the window ribs. The thickness of the window ribs can increase the height of the camera module, restricting the camera module from having a smaller height.

Korean Patent Publication 2011-0051947 (Date of Publication: Mar. 4, 2011) discloses a camera module. The camera module has ribs protruded on an inside face of the housing thereof, and an IR filter is attached to the bottom face of the ribs.

### SUMMARY

An embodiment of the present invention provides a camera module that can reduce its height.

An aspect of the present invention features a camera module, which includes: a housing; a lens barrel arranged inside the housing; an infrared filter fixed to one side of the lens barrel and having a window layer coated thereon so as to form a window area; an image sensor arranged beneath the infrared filter so as to correspond to the window area; and a printed circuit board having the image sensor mounted thereon.

The window layer can be formed in the shape of a rectangular frame around the infrared filter.

The window layer can be coated on one surface of the infrared filter that is closer to the lens barrel or on one surface of the infrared filter that is closer to the image sensor.

The housing can have a receiving groove formed on an inside surface thereof so as to receive a girth of the infrared filter.

With the camera module in accordance with an embodiment of the present invention, the height of the camera module can be reduced because the window layer is formed on the infrared filter.

### BRIEF DESCRIPTION OF THE DRAWINGS

FIG. 1 shows a camera module in accordance with an embodiment of the present invention.

FIG. 2 shows an infrared filter of the camera module shown in FIG. 1.

FIG. 3 is a cross-sectional view of the camera module shown in FIG. 1.

### DETAILED DESCRIPTION

Since there can be a variety of permutations and embodiments of the present invention, a certain embodiment will be illustrated and described with reference to the accompanying drawings. This, however, is by no means to restrict the present invention to a certain embodiment, and shall be construed as including all permutations, equivalents and substitutes covered by the ideas and scope of the present invention. Throughout the description of the present invention, when describing a certain relevant conventional technology is determined to evade the point of the present invention, the pertinent detailed description will be omitted.

Hereinafter, a camera module in accordance with an embodiment of the present invention will be described with reference to the accompanying drawings.

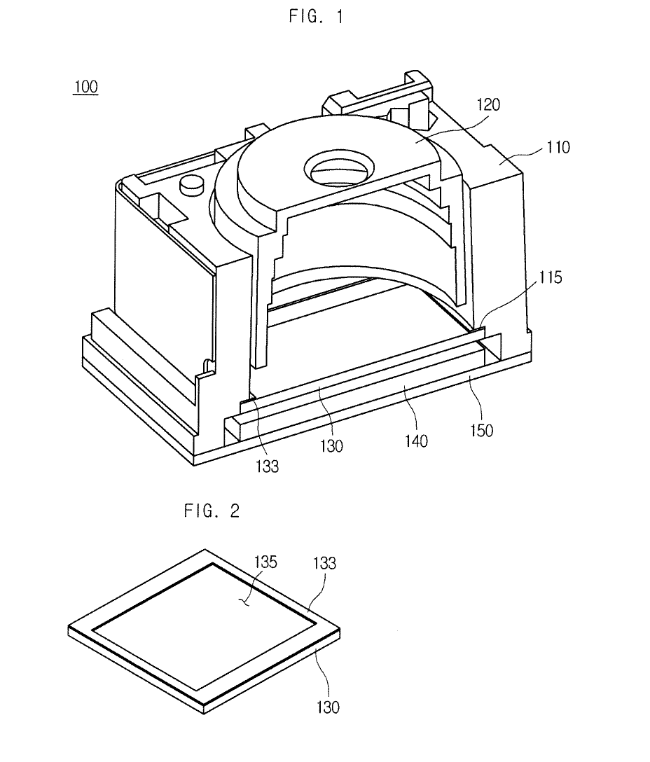

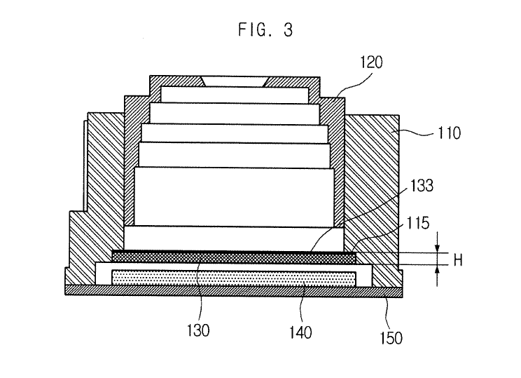

FIG. 1 shows a camera module in accordance with an embodiment of the present invention. FIG. 2 shows an infrared filter of the camera module shown in FIG. 1, and FIG. 3 shows a cross-sectional view of the camera module shown in FIG. 1.

Referring to FIGS. 1 to 3, a camera module 100 can include a housing 110, a lens barrel 120, an infrared filter 130, an image sensor 140 and a printed circuit board 150.

The housing 110 can have the lens barrel 120 coupled to an inside thereof. The lens barrel 120 can have lenses (not shown) arranged along an optical axis inside thereof. The lenses can be arranged to be separated by spacers (not shown). The lens barrel 120 can be tightly fixed or glued to the inside of the housing 110. Moreover, the lens barrel 120 can be a zoom type that can change a focus by moving the lenses.

In the case of the zoom type of camera module 100, an actuator (not shown) can be arranged between the lens barrel 120 and the housing 110. The actuator moves the lens barrel 120 when electric power is applied. Various kinds of structures can be applied for the actuator.

The lens barrel 120 can have the infrared (IR) filter 130 installed on one side thereof. The IR filter 130 filters light that has passed through the lenses and provides the filtered light to the image sensor 140.

The IR filter 130 can be fixed at one side of the lens barrel 120. Here, the housing 110 can have a receiving groove 115 formed on an inside surface thereof so as to receive a girth of the IR filter 130. The receiving groove 115 can be formed at a location that is separated from an end part of the lens barrel 12 by a certain distance. The IR filter 130 can be glued to the receiving groove 115.

The IR filter 130 can have a window layer 133, in which a window area 135 is formed, coated thereon. The window layer 133 is an opaque coating layer that prevents light from permeating. The window layer 133 can be formed in the shape of a rectangular frame around the IR filter 130. Here, a rectangular shape of the window area 135 can be formed in a center area of the window layer 133. Since the window area 133 is coated on one face of the IR filter 130, it is not necessary to form a rib, which is for forming the window area 135, on the inside surface of the housing 110. Accordingly, the overall height of the camera module 100 can be reduced by as much as a thickness of the rib for forming the window area 135.

Moreover, since the window layer 133 is coated on one face of the IR filter 130, a thickness (H) of the IR filter 130 is hardly increased. Therefore, since the thickness (H) of the IR filter 130 is hardly increased, it is possible to reduce the overall height of the camera module 100.

Moreover, since no rib is formed toward a center area of the housing 110 on the inside surface of the housing 110, the freedom of design can be greatly improved when a mold for the housing 110 is prepared. Furthermore, since the mold of the housing 110 is formed in a simple structure, the manufacturing cost of the mold can be saved.

The window layer 133 can be coated on one surface of the IR filter 130 that is closer to the lens barrel 120. Here, since the opaque window layer 133 makes a direct contact with the receiving groove 115 of the housing 110, it is possible to prevent any spill light or infrared ray from penetrating through a gap between the IR filter 130 and the receiving groove 115. It is also possible that the window layer 133 is coated on one surface of the IR filter 130 that is closer to the printed circuit board 150.

This IR filter 130 filters the light that is incident through the lenses and provides the filtered light to the image sensor 140.

The image sensor 140 can be arranged beneath the IR filter 130. The image sensor 140 can be arranged to correspond to the window area 135. The image sensor 140 can be arranged to be separated from the IR filter 130.

The printed circuit board 150 can be arranged in a lower portion of the housing 110. The printed circuit board 150 can have the image sensor 140 mounted thereon. The image sensor 140 can be electrically connected with a circuit of the printed circuit board 150.

Although a certain embodiment of the present invention has been described above, it shall be appreciated that there can be a variety of permutations and modifications of the present invention by those who are ordinarily skilled in the art to which the present invention pertains without departing from the technical ideas and scope of the present invention, which shall be defined by the appended claims. It shall be also appreciated that a large number of other embodiments than the above-described embodiment are included in the claims of the present invention.

What is claimed is:

1. A camera module comprising:
a housing;
a lens barrel arranged inside the housing;
an infrared filter fixed to one side of the lens barrel and having a window layer coated thereon so as to form a window area;
an image sensor arranged beneath the infrared filter so as to correspond to the window area; and
a printed circuit board having the image sensor mounted thereon.

2. The camera module of claim 1, wherein the window layer is formed in the shape of a rectangular frame around the infrared filter.

3. The camera module of claim 2, wherein the window layer is coated on one surface of the infrared filter that is closer to the lens barrel or on one surface of the infrared filter that is closer to the image sensor.

4. The camera module in accordance with any one of claims 1 to 3, wherein the housing has a receiving groove formed on an inside surface thereof so as to receive a girth of the infrared filter.
